(19) United States
(12) Patent Application Publication
(10) Pub. No.: US 2014/0083068 A1
(43) Pub. Date: Mar. 27, 2014

(54) LAWN MOWER DECK LIFTING LINK

(71) Applicant: Ariens Company, Brillion, WI (US)

(72) Inventor: Brent P. Berglund, Brillion, WI (US)

(73) Assignee: Ariens Company, Brillion, WI (US)

(21) Appl. No.: 13/975,580

(22) Filed: Aug. 26, 2013

Related U.S. Application Data
(60) Provisional application No. 61/703,909, filed on Sep. 21, 2012.

(51) Int. Cl. A01D 34/74; A01D 34/64

(52) U.S. Cl. CPC A01D 34/74; A01D 34/64
USPC 56/14.7; 74/469

(57) ABSTRACT

A lifting assembly for a mower deck includes a lifting shank having a curved surface following a lifting shank radius of curvature, and a deck lifting link interconnecting the mower deck lifting assembly and the mower deck. Actuation of the mower deck lifting assembly lifts the mower deck through the deck lifting link. The deck lifting link includes a slot having a width of more than twice the lifting shank radius of curvature and a slot end describing an arc having a radius of curvature substantially equal to the lifting shank radius of curvature. The lifting shank is received in the slot end with substantially surface contact between the lifting shank curved surface and the slot end. The lifting shank is freely movable in the slot to accommodate vertical travel of the mower deck with respect to the deck lifting assembly.

### BACKGROUND

The present invention relates to a lifting link for use in a lifting assembly for a cutting deck of a lawn mower.

### SUMMARY

In one embodiment, the invention provides a lawn mower comprising: a frame; a prime mover supported by the frame; a mower deck; a cutting blade mounted below the mower deck to cut vegetation under the mower deck; a mower deck lifting assembly for raising and lowering the mower deck, the mower deck lifting assembly including a lifting shank having a curved surface following a lifting shank radius of curvature; and a deck lifting link interconnecting the mower deck lifting assembly and the mower deck, such that actuation of the mower deck lifting assembly lifts the mower deck through the deck lifting link, the deck lifting link including a slot having a width of more than twice the lifting shank radius of curvature and having a slot end describing an arc having a radius of curvature substantially equal to the lifting shank radius of curvature; wherein the lifting shank is received in the slot end with substantially surface contact between the lifting shank curved surface and the slot end; and wherein the lifting shank is freely movable in the slot to accommodate vertical travel of the mower deck with respect to the deck lifting assembly.

In some embodiments, the mower deck includes a deck shank having a curved surface following a deck shank radius of curvature; wherein the slot in the deck lifting link comprises a first slot; wherein the deck lifting link further comprises a second slot, the second slot having a width of more than twice the deck shank radius of curvature and having a slot end describing an arc having a radius of curvature substantially equal to the deck shank radius of curvature; wherein the deck shank is received in the slot end of the second slot with substantially surface contact between the deck shank curved surface and the slot end; and wherein the deck shank is freely movable in the second slot to accommodate vertical travel of the mower deck with respect to the deck lifting link. In some embodiments, the first slot is longer than the second slot. In some embodiments, the deck lifting link is a monolithic component containing both the first and second slots. In some embodiments, the first and second slot include equal slot widths and equal slot end radii of curvature; and wherein the lifting shank radius of curvature is substantially equal to the deck shank radius of curvature.

The invention also provides a deck lifting link for interconnecting a mower deck lifting assembly and a mower deck on a lawnmower, the mower deck lifting assembly including a lifting shank having a curved surface of a radius curvature, the deck lifting link comprising: a monolithic body; a slot formed in the monolithic body, the slot having a width of more than twice the lifting shank radius of curvature and having a slot end describing an arc having a radius of curvature substantially equal to the lifting shank radius of curvature; wherein the lifting shank is received in the slot end with substantially surface contact between the lifting shank curved surface and the slot end; and wherein the lifting shank is freely movable in the slot to accommodate vertical travel of the mower deck with respect to the deck lifting assembly.

In some embodiments, the mower deck includes a deck shank having a curved surface following a deck shank radius of curvature; wherein the slot in the deck lifting link comprises a first slot; wherein the deck lifting link further comprises a second slot, the second slot having a width of more than twice the deck shank radius of curvature and having a slot end describing an arc having a radius of curvature substantially equal to the deck shank radius of curvature; wherein the deck shank is received in the slot end of the second slot with substantially surface contact between the deck shank curved surface and the slot end; and wherein the deck shank is freely movable in the second slot to accommodate vertical travel of the mower deck with respect to the deck lifting link. In some embodiments, the first slot is longer than the second slot. In some embodiments, the deck lifting link is a monolithic component containing both the first and second slots. In some embodiments, the first and second slot include equal slot widths and equal slot end radii of curvature; and wherein the lifting shank radius of curvature is substantially equal to the deck shank radius of curvature.

### BRIEF DESCRIPTION OF THE DRAWINGS

FIG. 1 is a perspective view of a lawn mower including a deck lifting assembly according to the present invention.

FIG. 2 is a perspective view of the deck lifting assembly.

FIG. 3 is a side view of the top slot of the deck lifting link.

FIG. 4 is a side view of the bottom slot of the deck lifting link.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

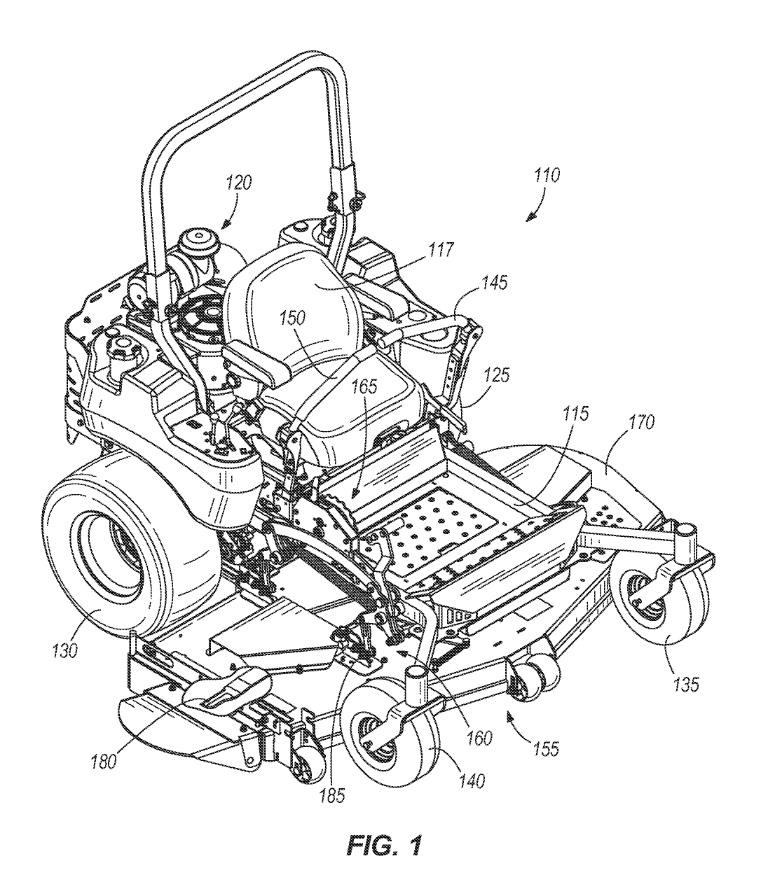

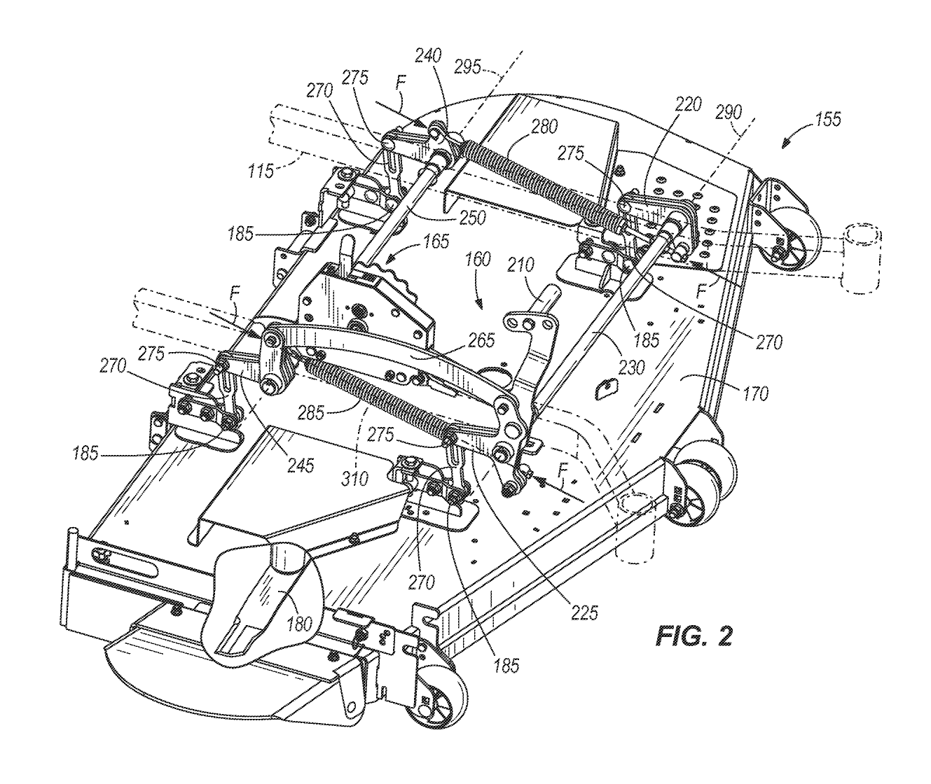

FIGS. 1 and 2 illustrate a lawn mower 110 including a frame 115, a seat 117, a prime mover 120, left and right driven wheels 125, 130, left and right passive wheels 135, 140, left and right control arms 145, 150, a deck assembly 155, a deck lifting assembly 160, and a height-of-cut assembly 165. The terms “front,” “rear,” “left,” and “right” will be used in this specification from the perspective of an operator seated on the lawn mower 110 during ordinary operation. The frame 115 is supported by the driven wheels 125, 130 and passive wheels 135, 140, and in turn supports the other components of the lawn mower 110. The prime mover 120 may be, for example, a gasoline powered internal combustion engine, but may also be any other type of prime mover such as an electric motor, a hybrid gas/electric motor, a fuel cell, or any other suitable device operating on a suitable fuel.

The left and right driven wheels 125, 130 are interconnected with the prime mover 120 through a power transmission and suitable hydraulic pumps and motors. The hydraulic pumps and motors are manipulated with the left and right control arms 145, 150, with the left control arm 145 controlling the direction and speed of rotation of the left driven wheel 125 and the right control arm 150 controlling the direction and speed of rotation of the right driven wheel 130.

The illustrated lawn mower 110 may be referred to as a zero-turn-radius lawn mower or ZTR lawn mower because when one of the control arms 145, 150 is pressed forward and the other control arm 145, 150 is pulled rearward, the lawn mower 110 will move in a very tight radius owing to one wheel rotating forward and the other rotating backwards. A ZTR lawn mower steers through the speed and direction difference of the two driven wheels. Further, the illustrated lawn mower 110 is a sitting lawn mower, in which the operator sits in the seat 117 during operation. The deck lifting assembly 160 discussed below is applicable to this type of lawn mower and also to any other type of lawn mower having a mower deck. Examples of other types of lawn mowers include large walk-behind units, standing mowers (in which the operator stands during operation), and tractors (in which a steering wheel is used instead of control arms, and the mower is not designed to execute zero-radius turns).

The deck assembly 155 includes a deck 170 and multiple cutting blades 180. The prime mover 120 drives rotation of the cutting blades 180 to cut vegetation (e.g., grass) under the deck 170. The deck 170 includes a plurality of mounting brackets with horizontal deck bolts 185.

The deck lifting assembly 160 includes a foot pedal 210, left and right front lifting brackets 220, 225, a front pivot shaft 230, left and right rear lifting brackets 240, 245, a rear pivot shaft 250, a right synchronizing arm 265, a lifting link 270 associated with each of the front and rear lifting brackets 220, 225, 240, 245, a lifting bolt 275 associated with each of the front and rear lifting brackets 220, 225, 240, 245, and left and right biasing members 280, 285. The foot pedal 210 is in the operator zone, which is defined as the region accessible by an operator on the lawn mower during ordinary operation. The foot pedal 210 is interconnected with the front pivot shaft 230 or with one of the front lifting brackets 220, 225, such that pivotal movement of the foot pedal 210 (e.g., under the influence of the operator's leg and foot) actuates the deck lifting assembly 160. Other types of deck lift actuators may be employed in place of or in addition to the foot pedal 210, including hand lever.

The left and right front lifting brackets 220, 225 are rigidly mounted to opposite ends of the front pivot shaft 230, and the left and right rear lifting brackets 240, 245 are rigidly mounted to opposite ends of the rear pivot shaft 250. The front pivot shaft 230 defines a front pivot axis 290 and the rear pivot shaft 250 defines a rear pivot axis 295. The front lifting brackets 220, 225 pivot about the front pivot axis 290 with the front pivot shaft 230, and the rear lifting brackets 240, 245 pivot about the rear pivot axis 295 with the rear pivot shaft 250.

The right synchronizing arm 265 is pinned to each of the right front lifting bracket 225 and right rear lifting bracket 245. The right synchronizing arm 265 and the front and rear pivot shafts 230, 250 ensure that the front and rear lifting brackets 220, 225, 240, 245 pivot in a synchronized fashion.

The lifting links 270 are pinned at a top end to the lifting bolts 275 and at a bottom end to the deck bolts 185, and are thus interconnected between an associated lifting bracket 220, 225, 240, 245 and the deck 170. Each lifting bracket 220, 225, 240, 245 pivots about the associated horizontal pivot axis 290, 295 in a raising direction that lifts the deck 170 through the lifting link 270, and a lowering direction that permits the deck 170 to lower under the influence of gravity. In the illustrated embodiment, the raising direction of the right side lifting brackets 225, 245 is clockwise as seen from the right side. The raising direction of the left side lifting brackets 220, 240 is counterclockwise when viewed from the left side.

The left and right biasing members 280, 285 are provided in the form of linear coil springs, but in other embodiments can be any suitable alternative, such as air springs, torsion springs, compound springs having non-linear spring constants, and resilient material. The left biasing member 280 is interconnected at one end to the left front lifting bracket 220 and is interconnected at the opposite end to the left rear lifting bracket 240. The right biasing member 285 is interconnected at one end to the right front lifting bracket 225 and is interconnected at the opposite end to the right rear lifting bracket 245.

The biasing members 280, 285 directly apply torque in the raising direction on both brackets to which they are interconnected, which assists the operator lifting the deck assembly 155 through the foot pedal 210. The illustrated biasing members 280, 285 are linear springs that are characterized by a spring constant that results in a biasing force F when the spring is extended. The spring force F acts on each of the lifting brackets to which the spring is attached, directed along a longitudinal extent or longitudinal axis 310 of the spring. The illustrated linear springs operate in tension and may therefore also be called tension springs.

Variations in the illustrated embodiment fall within the scope of the present invention. For example, the shafts 230, 250 could be configured at 90° from the positions shown, so they extend forward and rearward along the respective left and right sides. The deck lifting brackets 220, 225, 240, 245 would also be turned 90° so that they pivot about horizontal axes 290, 295 extending forward and rearward.

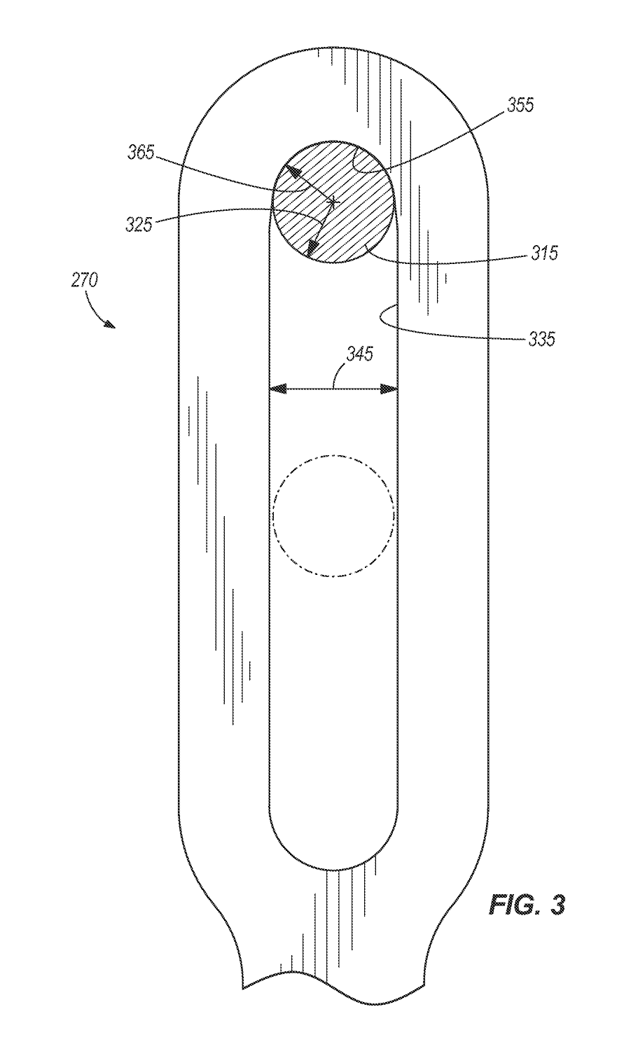

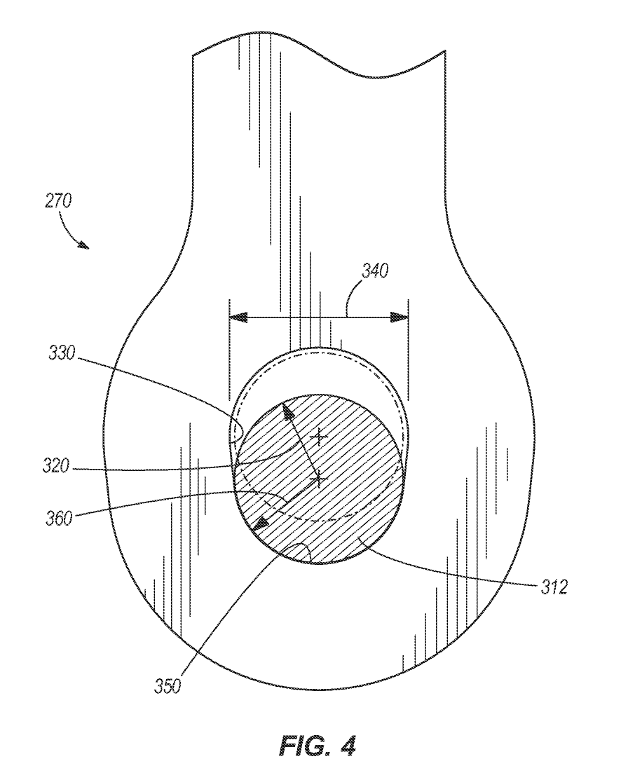

Referring now to FIGS. 3 and 4, the deck bolts 185 and lifting bolts 275 are identical parts in the illustrated embodiment. The deck bolts 185 include a deck shank 312 and the lifting bolts 275 include a lifting shank 315. Each bolt 185, 275 also includes a head, but for the purposes of interacting with the lifting links 270, the shanks 312, 315 are of primary importance. The shanks 312, 315 are generally smooth and cylindrical and provide a curved bearing surface characterized by a radius of curvature 320, 325. The bolts 185, 285 are provided for example only; in other embodiments, alternative mounting elements such as a pin, stub shaft, or other element having a shank with a curved bearing surface can be substituted for the bolts 185, 285.

The deck lifting link 270 includes a bottom slot 330 and a top slot 335. The top slot 335 is longer than the bottom slot 330, but they otherwise have the same dimensions as will be discussed. In other embodiments, the bottom slot 330 may be the longer slot or the two slots 330, 335 can have equal length. The deck lifting link 270 is a monolithic component, which means a component including no subparts that move with respect to each other, as distinguished from a chain, for example, which includes multiple links that move with respect to each other. Thus, the slots 330, 335 can be said to be formed in the monolithic body of the lifting link 270.

Each slot 330, 335 has a width 340, 345 and includes a slot end 350, 355 having a radius of curvature 360, 365 that is less than half the slot width 340, 345. The radius of curvature 360, 365 of the slot end 350, 355 is substantially equal to the radius of curvature 320, 325 of the deck shank 312 and the lifting shank 315. “Substantially equal” means that the radii of curvature 320, 325, 360, 365 are the same, within manufacturing tolerances. In the event, due to manufacturing tolerances, the radius of curvature 360, 365 of the slot end 350, 355 is not equal to the radius of curvature 320, 325 of the shank 312, 315, one of the parts will wear against the other and the parts will seat snugly together. The deck shank 312 and lifting shank 315 are received in the slot ends 350, 355 of the respective slots 330, 335 with substantially surface contact between the shanks 312, 315 and the slot ends 350, 355. The surface contact extends over about a 180° arc length in the illustrated embodiment, but may be less than 180° in other embodiments.

Achieving surface contact may lead to less wear on the components than arrangements that have point or line contact. In the environment of a lawn mower, in which there is vibration and impact loading, the parts can wear rapidly and will need to be recalibrated or replaced. The present arrangement with surface contact can reduce the rate at which the parts wear. The lifting links 270 can be retrofit onto existing mowers that use chains or other conventional means for connecting the deck lifting assembly 160 to the deck 170. The snug fit of the shanks 312, 315 in the slot ends 350, 355 of the monolithic lifting link 270 will also reduce noise compared to many known connection methods such as chains.

During operation of the lawn mower 110, the deck 170 or wheels 125, 130, 140, 145 will from time-to-time encounter bumps which will cause the deck assembly 155 to jump up with respect to the mower frame 115. Such relative movement is accommodated by the slots 330, 335. Because the slot width 340, 345 is larger than twice the radius (i.e., the diameter) of the shanks 312, 315, the shanks are removed from the slot ends 350, 355 and move within the slots 330, 335 freely, as illustrated in phantom. The free movement of the shanks 312, 315 in the slots 330, 335 reduces the likelihood of binding so that sudden vertical travel of the deck 170 is easily accommodated.

In one exemplary embodiment, the deck lifting link is 6.574 inches long. The straight portion of the long slot is 2.375 inches long and 0.266 inches wide, the lower end of the slot having a radius of curvature equal to half the width of the slot, and the slot end having a radius of curvature of 0.253 inches. The short slot has a slot length of 0.125 inches between the ends, a width equal to the width of the long slot, a top end having a radius of curvature equal to the width of the slot, and the slot end having a radius of curvature of 0.253 inches. The part can be laser cut from a steel plate, for example.

Thus, the invention provides, among other things, a lawn mower with a deck lifting link including a slot having a width of more than twice a lifting shank radius of curvature and having a slot end describing an arc having a radius of curvature substantially equal to the lifting shank radius of curvature. Various features and advantages of the invention are set forth in the following claims.

What is claimed is:

1. A lawn mower comprising:
a frame;
a prime mover supported by the frame;
a mower deck;
a cutting blade mounted below the mower deck to cut vegetation under the mower deck;
a mower deck lifting assembly for raising and lowering the mower deck, the mower deck lifting assembly including a lifting shank having a curved surface following a lifting shank radius of curvature; and
a deck lifting link interconnecting the mower deck lifting assembly and the mower deck, such that actuation of the mower deck lifting assembly lifts the mower deck through the deck lifting link, the deck lifting link including a slot having a width of more than twice the lifting shank radius of curvature and having a slot end describing an arc having a radius of curvature substantially equal to the lifting shank radius of curvature;
wherein the lifting shank is received in the slot end with substantially surface contact between the lifting shank curved surface and the slot end; and
wherein the lifting shank is freely movable in the slot to accommodate vertical travel of the mower deck with respect to the deck lifting assembly.

2. The lawn mower of claim 1, wherein the mower deck includes a deck shank having a curved surface following a deck shank radius of curvature; wherein the slot in the deck lifting link comprises a first slot; wherein the deck lifting link further comprises a second slot, the second slot having a width of more than twice the deck shank radius of curvature and having a slot end describing an arc having a radius of curvature substantially equal to the deck shank radius of curvature; wherein the deck shank is received in the slot end of the second slot with substantially surface contact between the deck shank curved surface and the slot end; and wherein the deck shank is freely movable in the second slot to accommodate vertical travel of the mower deck with respect to the deck lifting link.

3. The lawn mower of claim 2, wherein the first slot is longer than the second slot.

4. The lawn mower of claim 2, wherein the deck lifting link is a monolithic component containing both the first and second slots.

5. The lawn mower of claim 2, wherein the first and second slot include equal slot widths and equal slot end radii of curvature; and wherein the lifting shank radius of curvature is substantially equal to the deck shank radius of curvature.

6. A deck lifting link for interconnecting a mower deck lifting assembly and a mower deck on a lawnmower, the mower deck lifting assembly including a lifting shank having a curved surface of a radius curvature, the deck lifting link comprising:
a monolithic body;
a slot formed in the monolithic body, the slot having a width of more than twice the lifting shank radius of curvature and having a slot end describing an arc having a radius of curvature substantially equal to the lifting shank radius of curvature;
wherein the lifting shank is received in the slot end with substantially surface contact between the lifting shank curved surface and the slot end; and
wherein the lifting shank is freely movable in the slot to accommodate vertical travel of the mower deck with respect to the deck lifting assembly.

7. The deck lifting link of claim 6, wherein the mower deck includes a deck shank having a curved surface following a deck shank radius of curvature; wherein the slot in the deck lifting link comprises a first slot; wherein the deck lifting link further comprises a second slot, the second slot having a width of more than twice the deck shank radius of curvature and having a slot end describing an arc having a radius of curvature substantially equal to the deck shank radius of curvature; wherein the deck shank is received in the slot end of the second slot with substantially surface contact between the deck shank curved surface and the slot end; and wherein the deck shank is freely movable in the second slot to accommodate vertical travel of the mower deck with respect to the deck lifting link.

8. The deck lifting link of claim 6, wherein the first slot is longer than the second slot.

9. The deck lifting link of claim 6, wherein the deck lifting link is a monolithic component containing both the first and second slots.

10. The deck lifting link of claim 6, wherein the first and second slot include equal slot widths and equal slot end radii of curvature; and wherein the lifting shank radius of curvature is substantially equal to the deck shank radius of curvature.
